(19) United States
(12) Patent Application Publication
(10) Pub. No.: US 2015/0076422 A1
(43) Pub. Date: Mar. 19, 2015

(54) METHOD FOR PRODUCING METAL OXIDE FILM AND METAL OXIDE FILM

(71) Applicants: Takahiro Shirahata, Tokyo (JP); Hiroyuki Orita, Tokyo (JP); Takahiro Hiramatsu, Tokyo (JP)

(72) Inventors: Takahiro Shirahata, Tokyo (JP); Hiroyuki Orita, Tokyo (JP); Takahiro Hiramatsu, Tokyo (JP)

(73) Assignee: TOSHIBA MITSUBISHI-ELECTRIC INDUSTRIAL SYSTEMS CORPORATION, Chuo-ku, Tokyo (JP)

(21) Appl. No.: 14/382,827

(22) PCT Filed: Mar. 28, 2012
(86) PCT No.: PCT/JP2012/058156

§ 371 Date: Sep. 4, 2014

(51) Int. Cl. C23C 18/12; H01B 1/08

(52) U.S. Cl. CPC C23C 18/1216; C23C 18/1291; H01B 1/08
USPC 252/519.52; 427/426; 427/427

(57) ABSTRACT

In the method for producing a metal oxide film according to the present invention, a solution containing an alkyl metal is sprayed onto a substrate placed under non-vacuum. Further, when the solution is sprayed, a dopant solution containing a dopant including an inorganic compound is sprayed onto the substrate.

### TECHNICAL FIELD

The present invention relates to a method for producing a metal oxide film and a metal oxide film and is applicable to a method for producing a metal oxide film for use in, for example, solar cells and electronic devices.

### BACKGROUND ART

Techniques such as metal organic chemical vapor deposition (MOCVD) and sputtering that use a vacuum are employed as the method for depositing a metal oxide film for use in, for example, solar cells and electronic devices. The metal oxide films produced by those methods for producing a metal oxide film have excellent film properties.

For example, a transparent conductive film produced by the above-mentioned method for producing a metal oxide film has a low resistance and, if the produced transparent conductive film is heated, its resistance does not increase.

Patent Literature 1 is an example of the prior literatures regarding the deposition of a zinc oxide film by the MOCVD technique. Patent Literature 2 is an example of the prior literatures regarding the deposition of a zinc oxide film by the sputtering technique.

### CITATION LIST

### Patent Literatures

Patent Literature 1: Japanese Patent Application Laid-Open No. 2011-124330
Patent Literature 2: Japanese Patent Application Laid-Open No. 09-45140 (1997)

### SUMMARY OF INVENTION

### Problems to be Solved by the Invention

Unfortunately, the MODVD technique requires a high cost in addition to requiring the use of materials that are unstable in the air, which makes it less convenient. Also, a plurality of apparatuses are required in producing a metal oxide film having a laminated structure by sputtering, which unfortunately increases an apparatus cost. Therefore, a method for producing a metal oxide film, which is capable of producing a low-resistance metal oxide film at low cost, is desired.

The present invention therefore has an object to provide a method for producing a metal oxide film, which is capable of producing a low-resistance metal oxide film at low cost. The present invention has another object to provide a metal oxide film deposited by the method for producing a metal oxide film.

### Means for Solving the Problems

To achieve the above-mentioned objects, a method for producing metal oxide film according to the present invention includes the steps of: (A) spraying a solution containing an alkyl metal onto a substrate placed under non-vacuum; and (B) spraying a dopant solution containing a dopant including an inorganic compound onto the substrate in the step (A).

### Effects of the Invention

The method for producing metal oxide film according to the present invention includes the steps of: (A) spraying a solution containing an alkyl metal onto a substrate placed under non-vacuum; and (B) spraying a dopant solution containing a dopant including an inorganic compound onto the substrate in the step (A).

As described above, the method for producing metal oxide film according to the present invention performs the deposition process for a metal oxide film on a substrate under non-vacuum. This reduces the cost for the deposition process (deposition apparatus cost), which also improves convenience.

The method for producing a metal oxide film according to the present invention sprays a solution containing an alkyl metal onto the substrate, to thereby deposit a metal oxide film. Owing to high reactivity of the alkyl metal, the substrate merely needs a heat treatment at low temperature (not higher than 200° C.) and does not need a heat treatment at high temperature.

The method for producing a metal oxide film according to the present invention sprays, onto the substrate, a solution containing an alkyl metal and a dopant solution containing a dopant including an inorganic compound, to thereby deposit a metal oxide film on the substrate. Therefore, a supply of a dopant solution to the substrate can prevent the inclusion of an organic material in the metal oxide film due to the supply of the dopant solution, which allows reducing a resistance of the metal oxide film to be deposited.

The object, features, aspects and advantages of the present invention will become more apparent from the following detailed description and the attached drawings.

### BRIEF DESCRIPTION OF THE DRAWINGS

FIG. 1 A diagram showing a relationship between the resistivity and the molar concentration ratio of metal oxide films deposited using a dopant solution in which a dopant composed of an organic compound is dissolved.

FIG. 2 A diagram showing a relationship between the film thickness and the molar concentration ratio of metal oxide films deposited using a dopant solution in which a dopant composed of an organic compound is dissolved.

FIG. 3 A diagram showing a relationship among the carrier concentration, the mobility, and the molar concentration ratio of metal oxide films deposited using a dopant solution in which a dopant composed of an organic compound is dissolved.

FIG. 4 A configuration diagram of a deposition apparatus for describing a method for depositing a metal oxide film according to the present invention.

FIG. 5 A diagram showing a relationship between the resistivity and the molar concentration ratio of a metal oxide film deposited using a dopant solution in which a dopant composed of an inorganic compound is dissolved.

FIG. 6 A diagram showing a relationship between the film thickness and the molar concentration ratio of a metal oxide film deposited using a dopant solution in which a dopant composed of an inorganic compound is dissolved.

FIG. 7 A diagram showing a relationship among the carrier concentration, the mobility, and the molar concentration ratio of a metal oxide film deposited using a dopant solution in which a dopant composed of an inorganic compound is dissolved.

FIG. 8 A diagram showing deposition conditions of the metal oxide films.

### DESCRIPTION OF EMBODIMENT

A method for producing a metal oxide film according to the present invention performs a deposition process under non-vacuum (at atmospheric pressure). Herein, a metal oxide film deposited under non-vacuum (at atmospheric pressure) can have high resistance. The present invention therefore provides a method for producing a metal oxide film, which is capable of suppressing an increase in the resistance of a metal oxide film deposited under non-vacuum (at atmospheric pressure).

The inventors carried out the method for producing a metal oxide film as described below.

The inventors prepared a solution containing an alkyl metal and also prepared a doping solution containing an organic compound including indium (In). Additionally, they prepared water as an oxidation source. They used zinc (Zn) as a metal element constituting the alkyl metal. Then, the inventors formed the solution, doping solution, and water into mist, and sprayed the misted solutions onto a heated substrate.

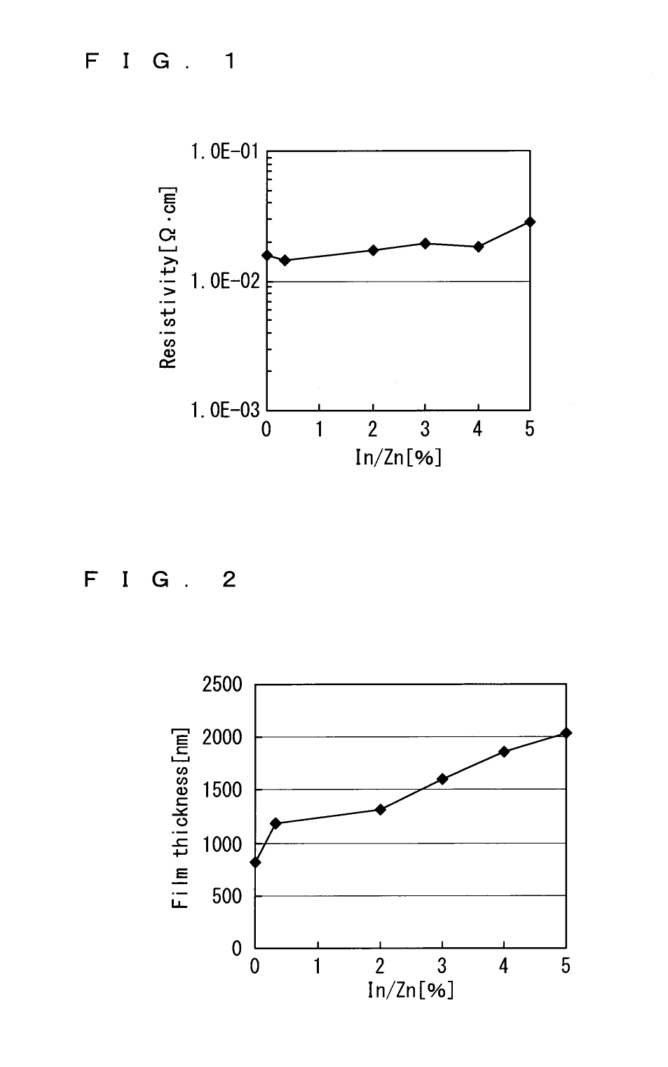

As described above, a metal oxide film was deposited on a substrate using the doping solution containing an organic compound, and resultantly, metal oxide films (zinc oxide films) having physical properties as shown in the experimental results of FIGS. 1, 2, and 3 were deposited.

FIG. 1 shows experimental results showing a relationship between the resistivity of the deposited metal oxide films and the molar concentration ratio of indium to zinc (a vertical axis and a horizontal axis indicate a resistivity (Ω·cm) and an In/Zn molar concentration (%), respectively).

FIG. 2 shows experimental results showing a relationship between the film thickness of the deposited metal oxide films and the molar concentration ratio of indium to zinc (a vertical axis and a horizontal axis indicate a film thickness (nm) and an In/Zn molar concentration (%), respectively).

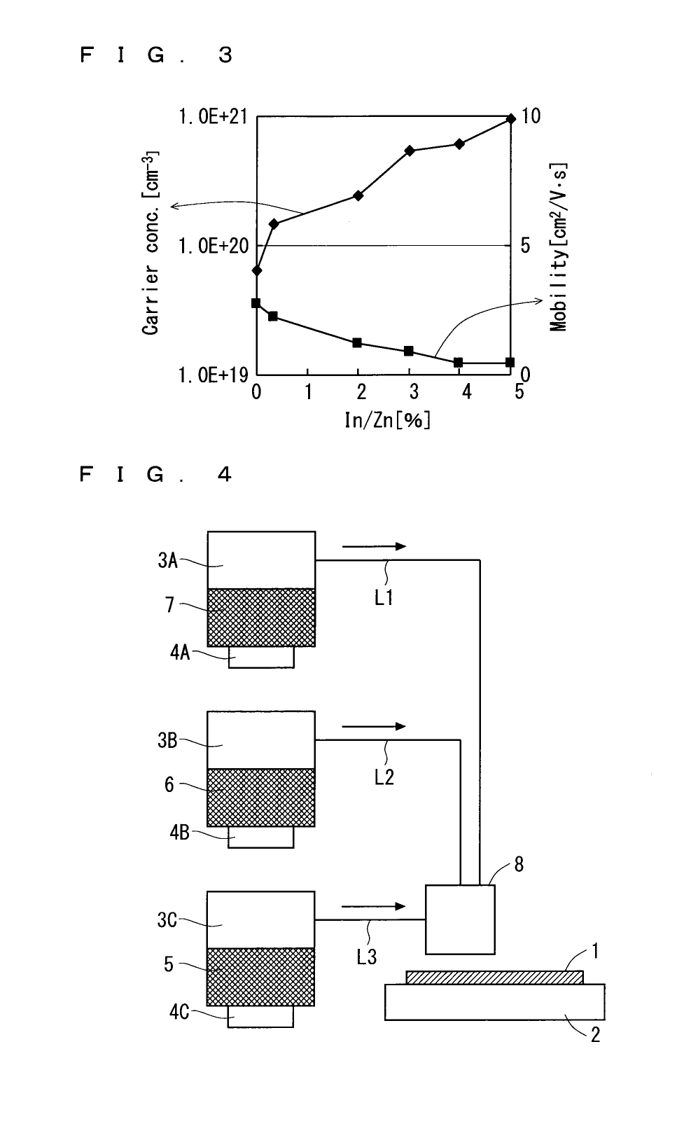

FIG. 3 shows experimental results showing a relationship among the carrier concentration, the mobility, and the molar concentration ratio of indium to zinc of the deposited metal oxide films (a left vertical axis, a right vertical axis, and a horizontal axis indicate a carrier concentration (cm⁻³), a mobility (cm²/V·s), and an In/Zn molar concentration ratio (%), respectively).

To reduce the resistance of the metal oxide film, a dopant (indium) was introduced into the metal oxide film. As shown in FIG. 1, however, the resistivity of the metal oxide film deposited by the above-mentioned production method does not decrease even if a dopant concentration is increased.

To be more specific, for the metal oxide film deposited by the above-mentioned production method, the resistivity of the metal oxide film containing a dopant tends to be larger than the resistivity of an undoped metal oxide film (In/Zn=0%). Also, as shown in FIG. 1, the resistivity of the metal oxide film tends to increase if the dopant concentration is increased.

FIG. 3 shows the obtained experimental results showing that as the dopant concentration increases, the mobility decreases though the carrier concentration increases (the data of FIG. 3 should partly show such a tendency that in a case where the resistance of the metal oxide film is reduced by dopant introduction, the mobility at which a dopant concentration increases also increases, but FIG. 3 does not show such a tendency).

In other words, FIG. 3 also shows that, even if a dopant concentration is increased, the resistivity of a metal oxide film deposited by the above-mentioned production method tends to increase more than the resistivity of an undoped metal oxide film.

The inventors have considered various aspects, for example, an aspect that the film thickness of a metal oxide film to be deposited increases largely as the dopant concentration increases a little as shown in FIG. 2, and another aspect that the mobility deteriorates and the resistance increases even if the dopant concentration is increased as shown in FIG. 3, and then have found the following.

The inventors have found that the resistance of a metal oxide film to be disposed increases even if the dopant concentration is increased by adopting a dopant solution containing an organic compound. The inventors have also found that when they adopt a dopant solution containing an inorganic compound, the dopant concentration is increased, which reduces the resistance of a metal oxide film to be deposited.

The present invention will be specifically described below with reference to the drawings showing an embodiment thereof

### Embodiment

The method for producing a metal oxide film according to this embodiment will be specifically described with the use of a production apparatus (deposition apparatus) shown in FIG. 4.

First, a solution 7 containing at least an alkyl metal is produced. Herein, zinc is used as a metal element contained in the solution 7. Also, an organic solvent such as ether or alcohol is used as a solvent of the solution 7. The produced solution 7 is filled into a container 3A as shown in FIG. 4.

Water (H₂O) is used as an oxidation source 6 and, as shown in FIG. 4, the oxidation source 6 is filled into a container 3B. While oxygen, ozone, hydrogen peroxide, N₂O, NO₂, and the like can be used as the oxidation source 6 in addition to water, water is desirably used in terms of inexpensive cost and easy handling (the oxidation source 6 is water in the following description).

Also, a dopant solution 5 containing a dopant composed of an inorganic compound is produced. For example, a boric acid (H₃BO₃) solution is usable as the dopant solution 5 containing a dopant composed of an inorganic compound. The produced dopant solution 5 is filled into a container 3C as shown in FIG. 4.

Next, the solution 5, the oxidation source 6, and the solution 7 are individually formed into mist. The container 3A is provided with an atomizer 4A on the bottom thereof, the container 3B is provided with an atomizer 4B on the bottom thereof, and the container 3C is provided with an atomizer 4C on the bottom thereof. The atomizer 4A forms the solution 7 in the container 3A into mist, the atomizer 4B forms the oxidation source 6 in the container 3B into mist, and the atomizer 4C forms the dopant solution 5 in the container 3C into mist.

The misted solution 7 passes through a path L1 to be supplied to a nozzle 8, the misted oxidation source 6 passes through a path L2 to be supplied to the nozzle 8, and the misted dopant solution 5 passes through a path L3 to be supplied to the nozzle 8. As shown in FIG. 4, herein, the path L1, the path L2, and the path L3 are different paths.

As shown in FIG. 4, a substrate 1 is placed on a heating unit 2. Herein, the substrate 1 is placed under non-vacuum (at atmospheric pressure). The misted solution 7, the misted oxidation source 6, and the misted dopant solution 5 are sprayed (supplied) onto the substrate 1 placed under non-vacuum (at atmospheric pressure) from discrete exhaust ports through the nozzle 8.

In this spraying, the substrate 1 is heated to, for example, about 200° C. by the heating unit 2.

The above-mentioned process deposits a metal oxide film (zinc oxide film being a transparent conductive film) having a predetermined film thickness on the substrate 1 placed under non-vacuum (at atmospheric pressure). As apparent from the above-mentioned process, in the present invention, the deposited metal oxide film not only contains zinc or the like but also contains a predetermined amount of dopant.

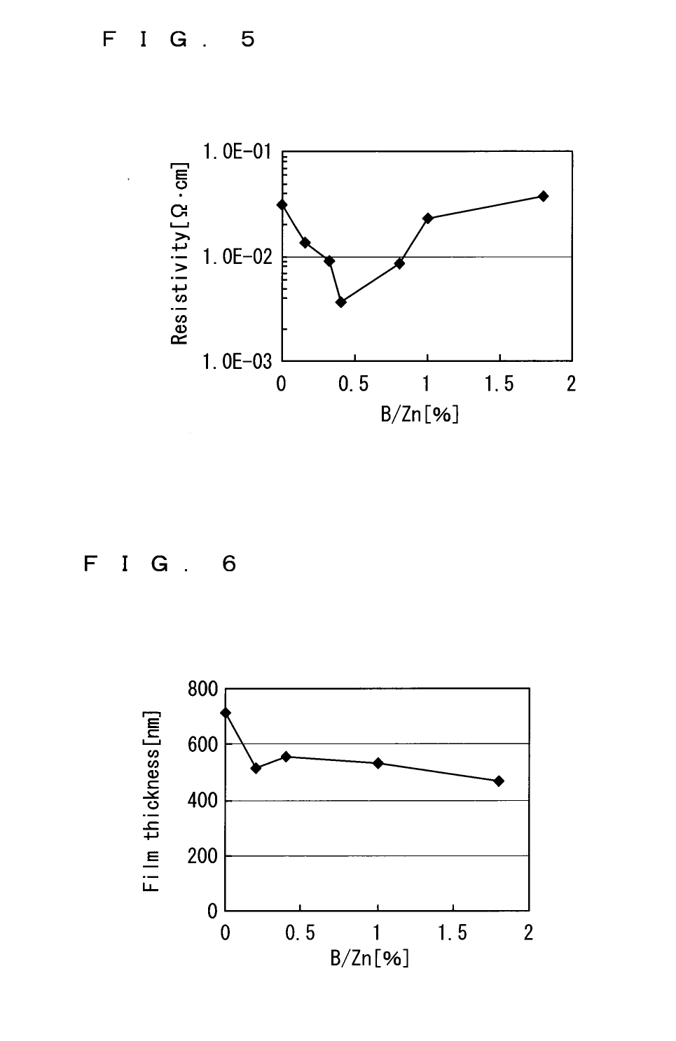

The above-mentioned method for producing a metal oxide film is used to form a plurality of metal oxide films by changing a molar concentration of a dopant (dopant contained in the dopant solution 5, which is boron in the description above) to be supplied to the substrate 1 as an inorganic compound with respect to a molar concentration of a metal element (metal element in the solution 7, which is zinc in the description above) to be supplied to the substrate 1 as an alkyl metal (hereinafter, a (dopant molar concentration)/(metal element molar concentration) is referred to as a molar concentration ratio). Then, the resistivity, film thickness, carrier concentration, and mobility of each metal oxide film were measured. FIGS. 5, 6, and 7 show the measurement results.

In the present invention, the molar concentration ratio is changeable by adjusting the carrier gas amount (liter/min) of the solution 7 to be supplied to the nozzle 8 (or the substrate 1), the molar concentration of zinc in the solution 7, the carrier gas amount (liter/min) of the dopant solution 5 to be supplied to the nozzle 8 (or the substrate 1), and the molar concentration of a dopant in the dopant solution 5.

The metal oxide films deposited and measured include a metal oxide film containing zinc that is undoped and a plurality of metal oxide films containing a dopant and zinc. Herein, the dopant is boron.

The plurality of metal oxide films containing a dopant and zinc include a metal oxide film having a B/Zn molar concentration of 0.16% when zinc and boron were supplied to the substrate 1, a metal oxide film having a B/Zn molar concentration of 0.32% when zinc and boron were supplied to the substrate 1, a metal oxide film having a B/Zn molar concentration of 0.4% when zinc and boron were supplied to the substrate 1, a metal oxide film having a B/Zn molar concentration of 1.0% when zinc and boron were supplied to the substrate 1, and a metal oxide film having a B/Zn molar concentration of 1.8% when zinc and boron were supplied to the substrate 1.

The deposition temperature for all the metal oxide films is 200° C. The metal oxide films were deposited in the deposition apparatus shown in FIG. 4, and the deposition conditions are as shown in FIG. 8.

As shown in FIG. 8, for the undoped metal oxide film, an amount of zinc supplied to the substrate 1 is 1.1 m (milli) mol/min, and an amount of the oxidizing agent (water) 6 supplied to the substrate 1 is 67 mmol/min.

As shown in FIG. 8, for the metal oxide films respectively having B/Zn molar concentration ratios of 0.16%, 0.32%, 0.4%, 0.8%, 1.0%, and 1.8%, an amount of zinc supplied to the substrate 1 is 1.1 mmol/min, and an amount of the oxidizing agent (water) 6 supplied to the substrate 1 is 67 to 133 mmol/min.

FIG. 5 shows measurement data showing a relationship between the resistivity and the molar concentration ratio of each metal oxide film deposited in the production apparatus of FIG. 4 on the above-mentioned deposition conditions. The vertical axis and horizontal axis of FIG. 5 indicate a resistivity (Ω·cm) and a B/Zn molar concentration ratio (%), respectively.

FIG. 6 shows measurement data showing a relationship between the film thickness and the molar concentration ratio of each metal oxide film deposited in the production apparatus of FIG. 4 on the above-mentioned deposition conditions. The vertical axis and horizontal axis of FIG. 6 indicate a film thickness (nm) and a B/Zn molar concentration ratio (%), respectively.

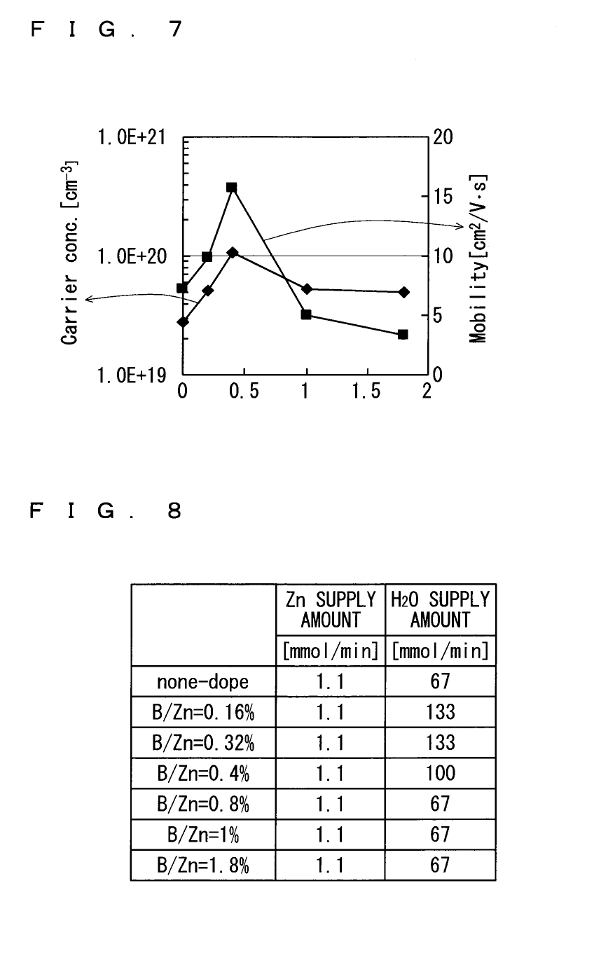

FIG. 7 shows measurement data showing a relationship among the carrier concentration, mobility, and molar concentration ratio of each metal oxide film deposited in the production apparatus of FIG. 4 on the above-mentioned deposition conditions. The left vertical axis, right vertical axis, and horizontal axis of FIG. 7 indicate a carrier concentration (cm⁻³), a mobility (cm²/V·s), and a B/Zn molar concentration ratio (%), respectively.

FIGS. 6 and 7 illustrate the measurement results of a metal oxide film containing zinc that is an undoped film and measurement results of the metal oxide films having B/Zn molar concentration ratios of “0.16%,” “0.4%,” “1.0%,” and “1.8%.”

A dopant composed of an organic compound is dissolved in a dopant solution, an alkyl metal is dissolved in a solution, and the dopant solution and the solution are sprayed onto the substrate 1, to thereby deposit a metal oxide film on the substrate 1.

In this case, as shown in FIG. 1, the resistivities of the metal oxide films that have been doped tended to become larger than the resistivity of the metal oxide film that is undoped. Also, as shown in FIG. 1, the resistivity of each metal oxide film tends to increase as the doping concentration is increased.

Meanwhile, by employing the method for producing a metal oxide film according to the present invention, a dopant composed of an inorganic compound is dissolved in the dopant solution 5, an alkyl metal is dissolved in the solution 7, and the dopant solution 5 and the solution 7 are sprayed onto the substrate 1, to thereby deposit a metal oxide film on the substrate 1.

In this case, as shown in FIG. 5, a doped metal oxide film can be formed, which has a resistivity lower than the resistivity of an undoped metal oxide film.

To be specific, as shown in FIG. 5, the resistivity of the undoped metal oxide film is substantially identical to the resistivity of the metal oxide film having a B/Zn molar concentration of 1.8%. Meanwhile, as shown in FIG. 5, the resistivities of the metal oxide films having B/Zn molar concentration ratios of 0.16%, 0.32%, 0.4%, 0.8%, and 1.0% are smaller than the resistivity of the undoped metal oxide film.

The measurement results shown in FIG. 5 show that the resistivities of the metal oxide films having a B/Zn molar concentration lower than 1.8% become lower than the resistivity of the undoped metal oxide film.

As shown in FIG. 5, as the B/Zn molar concentration ratio increases to 0.16%, 0.32%, and to 0.4%, the resistivity of the metal oxide film decreases suddenly and the resistivity of the metal oxide film having a B/Zn molar concentration of 0.4% takes a minimum value. As the B/Zn molar concentration ratio increases to 0.4%, 0.8%, 1.0%, and to 1.8%, the resistivity of the metal oxide film gradually rises. The resistivity of the metal oxide film having a B/Zn molar concentration ratio of 1.8% is substantially equal to the resistivity of the undoped metal oxide film.

Herein, FIG. 7 shows the presence of a B/Zn molar concentration ratio range in which as the B/Zn molar concentration increases, the carrier concentration increases and the mobility is improved as well. This shows that if a dopant composed of a predetermined amount of inorganic compound is supplied, the resistivity of a metal oxide film, deposited as the metal oxide film according to the present invention, decreases.

For the metal oxide film deposited by using a dopant composed of an organic compound, as shown in FIG. 2, the film thickness increases largely as the doping concentration is increased. It is conceivable that the increase is due to the inclusion of an organic matter contained in the dopant solution in the metal oxide film. Meanwhile, for a metal oxide film deposited by using a dopant composed of an inorganic compound as in the present invention, as shown in FIG. 6, the film thickness tends to become smaller as the doping concentration is increased.

The deposition conditions of the metal oxide films being measurement targets of FIGS. 1 to 3 and the deposition conditions of the metal oxide films being measurement targets of FIGS. 5 to 7 are mainly the same but are different in that whether a compound contained in the dopant solution is an organic compound or inorganic compound.

As described above, the method for producing a metal oxide film according to this embodiment performs the process of depositing a metal oxide film on the substrate 1 under non-vacuum. This reduces a cost for the deposition process (deposition apparatus cost) and also improves convenience.

The inventors have deposited metal oxide films using a solution containing a complex metal rather than an alkyl metal. In this case, the resistivity of the metal oxide film can be reduced even if a dopant composed of an organic compound is supplied to the substrate. However, due to high reactivity of the complex metal, the substrate 1 needs to be heated to a considerably high temperature in deposition.

Meanwhile, the method for producing a metal oxide film according to this embodiment sprays the solution 7 containing an alkyl metal onto the substrate 1, to thereby deposit a metal oxide film. The alkyl metal has high reactivity. Therefore, it suffices to perform a heat treatment at low temperature (not higher than 200° C.) on the substrate 1 in deposition, eliminating the need to perform a high-temperature heat treatment on the substrate 1.

The resistances of the metal oxide films, deposited by spraying a solution containing an alkyl metal and a dopant solution containing a dopant composed of an organic compound onto the substrate 1 placed under non-vacuum, tend to become higher as shown in the data of FIGS. 1 to 3.

The method for producing a metal oxide film according to this embodiment therefore sprays, onto the substrate 1 placed under non-vacuum, the solution 7 containing an alkyl metal and the dopant solution 5 containing a dopant composed of an inorganic compound, to thereby deposit a metal oxide film on the substrate 1.

The supply of the dopant solution 5 to the substrate 1 can prevent the inclusion of an organic matter in a metal oxide film due to the supply of the dopant solution 5, which allows reducing the resistance of a metal oxide film to be deposited. As described above, the method for producing a metal oxide film according to this embodiment can deposit a low-resistance metal oxide film through the low-temperature deposition process.

Differently from the deposition process under vacuum, the deposition process under non-vacuum (at atmospheric pressure) allows easy inclusion of an organic matter in a metal oxide film. The present invention including the step of spraying, onto the substrate 1, the dopant solution 5 containing a dopant composed of an inorganic compound is therefore more effective in the deposition process under non-vacuum (at atmospheric pressure).

Zinc has been illustrated as an alkyl metal to be dissolved in the solution 7. Alternatively, other metal elements may be used as long as they are alkyl metals, and cadmium (Cd) and magnesium (Mg) can be used.

The method for producing a metal oxide film according to this embodiment may use, as a dopant composed of an inorganic compound, boron phosphate (BPO₄), boron tribromide (BBr₃), gallium bromide (GaBr₃), gallium chloride (GaCl₃), gallium fluoride (GaF₃), gallium iodide (GaI₃), indium bromide (InBr₃), indium chloride (InCl₃), indium fluoride (InF₃), indium hydroxide (In(OH)₃), indium iodide (InI₃), aluminum bromide (AlBr₃), aluminum chloride (AlCl₃), aluminum fluoride (AlF₃), aluminum hydroxide (Al(OH)₃), aluminum iodide (AlI₃), and the like, in addition to boron described above.

The boron described above is used a dopant composed of an inorganic compound, leading to various effects described below.

Boron is a substance used stably and safely in the air, leading to more improved convenience. Boron is an inexpensive material, leading to a reduction in the producing cost for a metal oxide film. While the metal oxide film (in particular, a zinc oxide film or other film) is easily etched in a strong acid and a strong base, boron is a weak acid. Thus, even when boron is sprayed onto the substrate 1 as a dopant during deposition, a metal oxide film can be prevented from being etched during the deposition. The use of boron as a dopant composed of an inorganic compound prevents a situation in which the deposition of a metal oxide film on the substrate 1 is inhibited.

The resistivity of a metal oxide film can be reduced even when a solution containing a complex metal and a dopant solution containing boron are supplied to the substrate. However, as described above, the reactivity of the complex metal is low, and thus, the substrate needs to be heated to a sufficiently high temperature in deposition, which is contrary to a demand for a low-temperature process.

In the method for producing a metal oxide film according to this embodiment, during deposition, a molar concentration of a dopant (boron) composed of an inorganic compound to be supplied to the substrate 1 with respect to a molar concentration of an alkyl metal to be supplied to the substrate 1 is set to be smaller than 1.8%.

The molar concentration ratio is set to be smaller than 1.8% in a case where boron is used as a dopant composed of an inorganic compound, allowing for deposition of a metal oxide film that is doped and has a resistivity lower than the resistivity of the undoped metal oxide film as shown in FIG. 5.

In a case where an organic solvent is used as the solvent of the solution 5, a dopant composed of an inorganic compound may be insoluble in the solution 5. Therefore, as shown in FIG. 1, the solution 7 and the dopant solution 5 are housed in the different containers 3A and 3C, and the solution 7 and the dopant solution 5 are sprayed onto the substrate 1 through different systems L1 and L3 (that is, from different exhaust ports of the nozzle 8), to thereby prevent the above-mentioned problem.

In the present invention, the deposition process is performed under non-vacuum (at atmospheric pressure), allowing for the use of atmospheric oxygen as an oxidation source. Adoption of the configuration in which the oxidation source 6 is actively supplied to the substrate 1, as illustrated in FIG. 1, increases the deposition rate of a metal oxide film and also allows for deposition of a metal oxide film having a good film quality.

As shown in FIG. 1, the solution 7 and the oxidation source 6 are housed in the different containers 3A and 3B, and the solution 7 and the oxidizing agent 6 are sprayed onto the substrate 1 through the different systems L1 and L2 (that is, from different exhaust ports of the nozzle 8), limiting the reaction between the solution 7 and the oxidizing agent 6 to occur only on the substrate 1. In other words, the reaction between the solution 7 and the oxidizing agent 6 in the containers can be prevented, and also the reaction between the solution 7 and the oxidizing agent 6 in the supply paths leading to the substrate 1 can be prevented.

Ozone, oxygen, and the like can be used as the oxidizing agent 6. However, ozone has strong reactivity and oxygen has weak reactivity. Therefore, water is adopted as the oxidizing source 6. This allows the oxidizing agent 6 having appropriate reactivity to be sprayed onto the substrate 1 at low cost.

The deposition apparatus illustrated in FIG. 1 includes the container 3A for the solution 7, the container 3B for the oxidation source 6, and the container 3C for the dopant solution 5 that are independently provided. Alternatively, any of the containers 3A, 3B, and 3C can be omitted.

For example, the following configurations are adoptable: the solution 7 and the oxidation source 6 are put in the same one of the containers and the dopant solution 5 is put in the other container; the dopant solution 5 and the oxidation source 6 are put in the same one of the containers and the solution 7 is put in the other container; and the solution 7 and the dopant solution 5 are put in the same one of the containers and the oxidation source 6 is put in the other container.

Whether a container is provided for each of the solutions 5, 6, and 7 or a container is used in common for two solutions can be selected depending on the types of the dopant solution 7, the oxidation source 6, and the solution 5 (as an example, depending on the dopant solubility and the reactivity of each of the solutions 5, 6, and 7). For example, boric acid is soluble in water, and thus, boric acid being the dopant solution 5 and water being the oxidation source 6 can be put in the same container. It is difficult to put the solution 5 containing an organic solvent and the dopant solution 5 containing a dopant composed of an inorganic compound in the same container. To prevent the reaction between the solution 7 and the oxidation source 6 at the place other than the substrate 1, it is not preferable to put the solution 7 and the oxidation source 6 in the same container.

If the molar concentration ratio needs to be adjusted, it is preferable to adopt the configuration in which the containers 3A, 3B, and 3C are provided for the solutions 5, 6, and 7, respectively, and the solutions 5, 6, and 7 are supplied to the substrate 1 through the different systems L1, L2, and L3. This is because the above-mentioned configuration can adjust the molar concentration most easily.

The present invention has been described in detail, but the above-mentioned description is illustrative in all aspects and the present invention is not intended to be limited thereto. Various modifications not exemplified are construed to be made without departing from the scope of the present invention.

### DESCRIPTION OF REFERENCE SIGNS

1 substrate
2 heating unit
3A, 3B, 3C container
4A, 4B, 4C atomizer
5 dopant solution
6 oxidation source
7 solution
8 nozzle
L1, L2, L3 path

1. A method for producing metal oxide film, comprising:
(A) spraying a solution comprising an alkyl metal onto a substrate placed under non-vacuum; and
(B) spraying a dopant solution comprising a dopant comprising an inorganic compound onto the substrate in the spraying (A).

2. The method according to claim 1, wherein the dopant is boric acid.

3. The method according to claim 2, wherein in the spraying (A) and spraying (B), a molar concentration of the dopant supplied to the substrate with respect to a molar concentration of the alkyl metal supplied to the substrate is less than 1.8%.

4. The method according to claim 1, wherein in the spraying (A) and spraying (B), the solution and the dopant solution are supplied to the substrate through different systems.

5. The method according to claim 1, further comprising (D) spraying an oxidation source onto the substrate in the spraying (A) and spraying (B).

6. The method according to claim 5, wherein in the spraying (A) and (D), the solution and the oxidation source are supplied to the substrate through different systems.

7. The method according to claim 5, wherein in the spraying (A), (B), and (D), the solution, the oxidation source, and the dopant solution are supplied to the substrate through different systems.

8. The method according to claim 5, wherein the oxidation source is water.

9. A metal oxide film, produced by the method according to claim 1.
